(19) United States
(12) Patent Application Publication
(10) Pub. No.: US 2023/0118687 A1
(43) Pub. Date: Apr. 20, 2023

(54) RADIATION SHIELDING AND METHOD OF MANUFACTURE

(71) Applicant: OKLO, INC., Sunnyvale, CA (US)

(72) Inventors: Jacob DeWitte, Mountain View, CA (US); Joshua G. Richard, Sunnyvale, CA (US); Ethan Bates, Mountain View, CA (US); Samuel Doane, Sunnyvale, CA (US); Olorunsola Akinsulire, Sunnyvale, CA (US); David Hawn, Houston, TX (US); Patrick Everett, San Francisco, CA (US)

(21) Appl. No.: 17/906,062

(22) PCT Filed: Mar. 9, 2021
(86) PCT No.: PCT/US2021/021456

§ 371 Date: Sep. 9, 2022

Related U.S. Application Data
(60) Provisional application No. 62/987,124, filed on Mar. 9, 2020.

(51) Int. Cl. G21C 7/103; G21C 7/28; G21F 1/02; G21C 21/18

(52) U.S. Cl. CPC G21C 7/103; G21C 7/28; G21F 1/02; G21C 21/18

(57) ABSTRACT

Radiation shielding and methods of manufacture are disclosed. A radiation shielding apparatus includes a matrix including matrix material; and a mixture positioned in the matrix, the mixture including: a neutron thermalizing material; and a neutron absorbing material mixed with the neutron thermalizing material. A reactivity control system includes a container rotatable around an axis; a divider positioned inside the container to define two or more compartments within the container; at least one neutron absorber positioned in at least one of the two or more compartments; and at least one neutron reflector positioned in another of the two or more compartments that is fluidly isolated from the at least one of the two or more compartments. A method of manufacturing radiation shielding material includes: fabricating a matrix; generating a mixture by mixing a neutron absorbing material, a neutron thermalizing material, and additive materials; and loading the mixture into the matrix.

### CROSS-REFERENCE TO RELATED APPLICATIONS

This application claims the benefit under 35 U.S.C. § 119 of U.S. Provisional Patent Application Ser. No. 62/987,124 filed Mar. 9, 2020, which is incorporated herein by reference in its entirety.

### TECHNICAL FIELD

The present disclosure relates generally to radiation shielding, and more specifically to neutron shielding and photon shielding used in nuclear reactors, including neutron absorption related to the control of a reactor, as well as a method of making such shielding.

### BACKGROUND

Global energy growth and a drive to reduce pollution and emissions is stimulating new activity around the commercialization and design of new reactor technologies. Some of these technologies include small reactors designed to provide long lasting and resilient power in a more distributed fashion. Some of these reactors will benefit from enhanced shielding technologies that improve radiation shielding performance by improving neutron and photon attenuation characteristics, configuration flexibility, thermal performance, and ability to endure irradiation for extended periods of time.

### SUMMARY

In an example implementation, a nuclear reactor can include: fuel including a fissile material such as uranium-233, uranium-235, or plutonium-239; a coolant or cooling device, a heat exchanger to transfer the heat from the coolant or cooling device to a power conversion system, as well as instrumentation, supporting structures and shielding.

In an aspect combinable with the example implementation, the shielding is placed external to the fuel, in some or all directions, to attenuate photons and neutrons, and reduce neutron and photon fields away from the fuel.

In an aspect combinable with any of the previous aspects combining neutron shielding properties of multiple materials together in a homogeneous way, or in a functionally graded way, can result in improved shielding performance and economics compared to compositely layered shielding materials.

In an aspect combinable with any of the previous aspects, a homogeneous or functionally graded shielding material can include a hydrogenous material (or material of another low atomic number element such as lithium) that can directly thermalize neutrons, such as a metallic hydride. The material can also include a neutron absorber such as boron-bearing or gadolinium-bearing material.

In an aspect combinable with any of the previous aspects, the shielding material can contain a photon attenuating material, such as lead oxide or tungsten, which can slow down high energy neutrons via inelastic scattering. The shielding material can also contain thermally conductive materials, such as aluminum or helium, to improve thermal conductivity of the shielding.

In an aspect combinable with any of the previous aspects, the shielding material can contain insulating materials, such as metal oxides and ceramics, to reduce the thermal conductivity of the shielding. Insulating materials can be used in regions where components are subject to high temperatures, e.g., components that are positioned in close proximity to a reactor core.

In an aspect combinable with any of the previous aspects, the shielding material can also be used in control elements where the absorption properties of the shielding material can be used to enhance the control properties of the control elements.

In an aspect combinable with any of the previous aspects, neutron absorbing materials in a variety of compositions can be placed into control elements designed to control reactivity of the reactor. Control elements can take the form of absorbers and reflectors located on a periphery of the reactor core.

In an aspect combinable with any of the previous aspects, control elements can take the form of a rotating control drum that contains both a reflector including neutron reflecting materials, and an absorber including neutron absorbing materials. For example, the reflector can include neutron reflecting materials, such as metal or ceramic materials, including materials that contain zirconium, contained in a region of the drum. The absorber can include neutron absorbing materials, e.g., boron containing materials, contained in another region of the drum. The sizes and positions of the regions of the drum that house the reflector and the absorber can vary depending on control requirements of the drum, as well as the reactor design.

In an aspect combinable with any of the previous aspects, the rotating drum can include modular removable components, e.g., a motor assembly, a transmission, and a drum body.

In an aspect combinable with any of the previous aspects, the drum can be cylindrical and can be fabricated so that one half of the cylinder contains the reflector, and the other half of the cylinder contains the absorber.

In an aspect combinable with any of the previous aspects, the materials of the reflector and the absorber can be solid materials, composite materials, or granular material.

In an aspect combinable with any of the previous aspects, the granular material includes a powder.

In an aspect combinable with any of the previous aspects, the materials can be mixed or graded based on their neutron reflection and absorption characteristics to achieve the desired performance.

In an aspect combinable with any of the previous aspects, an apparatus includes a neutron thermalizing material and a neutron absorbing material mixed with the neutron thermalizing material to form a radiation shielding material.

In an aspect combinable with the example implementation, the neutron absorbing material is mixed with the neutron thermalizing material to form a homogeneous mixture.

In an aspect combinable with any of the previous aspects, the neutron absorbing material is mixed with the neutron thermalizing material to form a functionally graded mixture.

In an aspect combinable with any of the previous aspects, the neutron thermalizing material includes a hydrogenous material, such as lithium hydride.

In an aspect combinable with any of the previous aspects, the neutron absorbing material includes a boron-bearing material.

In an aspect combinable with any of the previous aspects, the neutron absorbing material includes a gadolinium-bearing material.

An aspect combinable with any of the previous aspects further includes a photon attenuating material.

An aspect combinable with any of the previous aspects further includes a thermally conductive material mixed with the neutron thermalizing material and the neutron absorbing material.

An aspect combinable with any of the previous aspects further includes an insulating material mixed with the neutron thermalizing material and the neutron absorbing material.

In another example implementation, a reactivity control mechanism includes: a container for housing a neutron absorber and a neutron reflector. The container is rotatable around an axis. A divider is positioned inside the container to define two or more compartments within the container. At least one neutron absorber positioned in one or more of the compartments; and at least one neutron reflector positioned in one or more of the compartments.

In an aspect combinable with the example implementation, the divider extends in one or more planes parallel to the axis.

In an aspect combinable with any of the previous aspects, the container has a cylindrical shape.

In an aspect combinable with any of the previous aspects, the two or more compartments are each of equal volume.

An aspect combinable with any of the previous aspects further includes: a transmission coupled to the container around the axis; and a motor coupled to the container through the transmission and configured to rotate the container around the axis through the transmission.

In another example implementation, a method of manufacturing a neutron shielding material includes: fabricating a matrix; generating a mixture by mixing a neutron absorbing material, a neutron thermalizing material, and one or more additive materials; and loading the mixture into the matrix.

In an aspect combinable with the example implementation, fabricating the matrix includes: fabricating matrix material; modifying the matrix material; and arranging the matrix material in a geometric configuration.

In an aspect combinable with any of the previous aspects, the matrix material includes one or more of metallic foams or porous media.

In an aspect combinable with any of the previous aspects, modifying the matrix material includes coating the matrix material.

An aspect combinable with any of the previous aspects further includes modifying the mixture by one or more of vibrational packing, gas addition, gas removal, or coating.

In another aspect combinable with any of the previous aspects, the neutron absorbing material, the neutron thermalizing material, and the one or more additive materials each include a granular material.

In an aspect combinable with any of the previous aspects, generating the mixture includes one or more of mixing the powders, packing the powders, or sintering the powders.

In an aspect combinable with any of the previous aspects, the sintering aids may include neutron or photon attenuating materials.

In an aspect combinable with any of the previous aspects, the mixture includes a homogeneous mixture.

In an aspect combinable with any of the previous aspects, the mixture includes a functionally graded mixture.

In an aspect combinable with any of the previous aspects, the neutron thermalizing material includes a hydrogenous material.

In an aspect combinable with any of the previous aspects, the neutron absorbing material includes a boron-bearing material.

In an aspect combinable with any of the previous aspects, the neutron absorbing material includes a gadolinium-bearing material.

In an aspect combinable with any of the previous aspects, the one or more additive materials include one or more of a photon attenuating material, a thermally conductive material, or an insulating material.

### BRIEF DESCRIPTION OF THE DRAWINGS

FIG. 1 shows a side cross-sectional view of a horizontal reactor configuration with radiation shielding.

FIG. 2 shows a side cross-sectional view of a horizontal reactor configuration with radiation shielding.

FIG. 3 shows a process diagram of a method of manufacture of the radiation shielding.

FIGS. 4A and 4B show a side view and a cross-sectional view of an example control drum, respectively.

FIG. 5 shows a top cross-sectional view of an example control drum body.

FIG. 6 shows a schematic diagram of a computer system.

### DETAILED DESCRIPTION

Implementations of the present disclosure will now be described in detail with reference to the drawings, which are provided as illustrative examples of inventive implementations so as to enable those skilled in the art to practice the example implementations. Notably, the figures and examples below are not meant to limit the scope of the present disclosure to a single implementation, but other implementations are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the example implementations. In the present specification, an implementation showing a singular component should not be considered limiting; rather, the disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

Global energy growth and a drive to reduce pollution and emissions is stimulating new activity around the commercialization and design of new reactor technologies. Some of these technologies include small reactors designed to provide long lasting and resilient power in a more distributed fashion. Some of these reactors will benefit from enhanced shielding technologies that improve neutron shielding performance by improving neutron and photon attenuation characteristics, configuration flexibility, thermal performance, and ability to endure irradiation for extended periods of time.

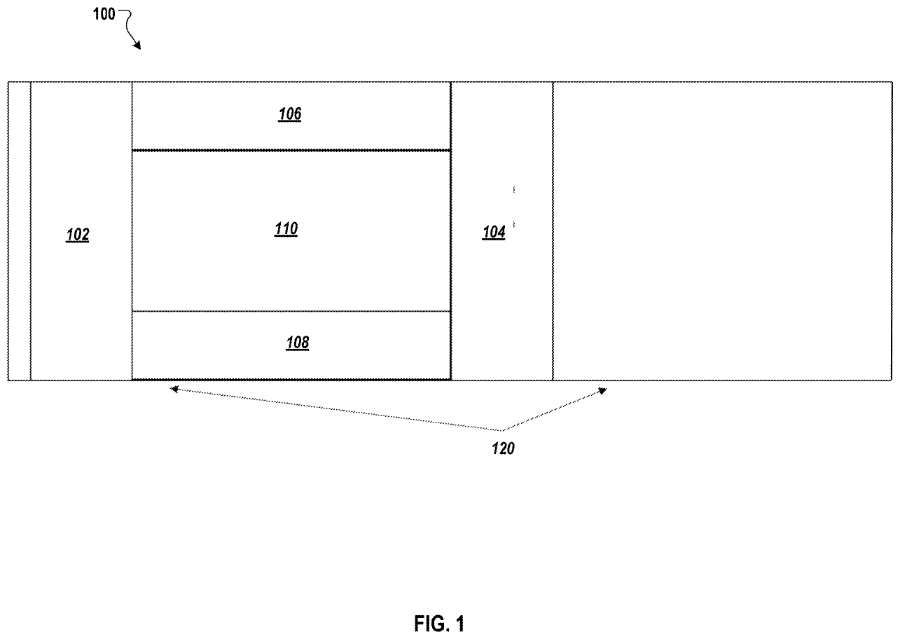

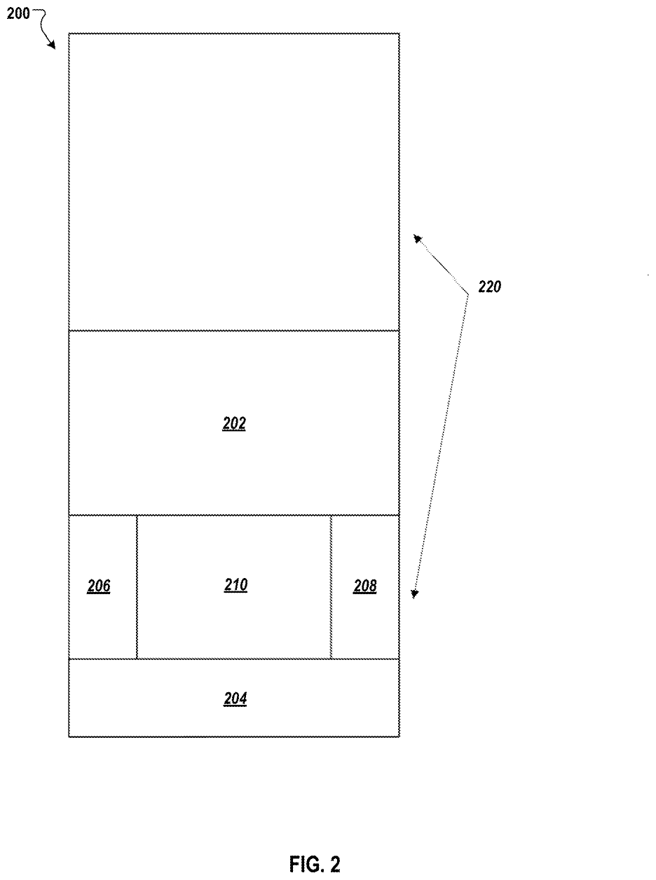

FIG. 1 shows a side cross-sectional view of a horizontal reactor configuration 100 with radiation shielding. FIG. 2 shows a side cross-sectional view of a vertical reactor configuration 200 with radiation shielding.

The radiation shielding can include multiple shielding regions placed around the fuel region. For example, the horizontal reactor configuration 100 includes side shielding regions 102, 104, upper shielding region 106, and lower shielding region 108. The shielding regions 102, 104, 106, 108 are within external reactor structure 120. The shielding regions 102, 104, 106, 108 surround fuel region 110.

The vertical reactor configuration 200 includes upper shielding region 202, lower shielding region 204, and side shielding regions 206, 208. The shielding regions 202, 204, 206, and 208 are within external reactor structure 220. The shielding regions 102, 104, 106, 108 surround fuel region 210.

The shielding regions of FIG. 1 and FIG. 2 can contain enhanced shielding materials, such as homogeneous or functionally graded shielding materials. The purpose of radiation shielding is to reduce radiation fields in areas away from the fuel regions 110, 210. Thus, the shielding can be placed external to the fuel, in some or all directions, to attenuate neutrons and photons. Combining neutron shielding properties of multiple materials together in a homogeneous way, or in a functionally graded way, can result in improved shielding performance and economics compared to compositely layered shielding materials.

A functionally graded shielding material can have a varied composition and structure. In some examples, a property of the shielding material may be vary along one or more directions. An example shielding material can be functionally graded in density. The functionally graded shielding material may be more dense near the fuel region 110, with density gradually decreasing along an outward radial direction. In another example, a functionally graded shielding material may be less dense near the fuel region 110, with density gradually increasing along an outward radial direction.

A homogeneous or functionally graded shielding material including hydrogenous material (or material of another low atomic number element like lithium) that can directly thermalize neutrons, such as a metallic hydride, and a neutron absorber such as boron-bearing or gadolinium-bearing material, can enhance the neutron shielding performance of the material. The homogeneous or functionally graded shielding material can enhance the neutron shielding performance, for example, by introducing highly moderating hydrogen to slow neutrons down in the presence of strong thermal neutron absorbers, increasing the material's ability to slow down and absorb neutrons.

The shielding material can also contain a photon attenuating material, such as lead oxide or tungsten, which can slow down high energy neutrons via inelastic scattering. The shielding material can also contain thermally conductive materials, such as aluminum, beryllium oxide, or silicon carbide, to improve thermal conductivity of the shielding. A high thermal conductivity backfill gas, such as helium, can replace the air within the interstitials of the absorber bed to improve the overall thermal conductivity.

In regions of the reactor core where it is desirable to impede heat transfer, e.g., in order to protect components from high temperatures, insulating materials such as ceramics and metal oxides can be added. Insulating materials can enhance the photon shielding performance of the system, while also providing inelastic scattering properties. Heat transfer property enhancements such as reducing the thermal conductivity can reduce shielding temperatures, while also improving heat removal capabilities of the shielding, which is particularly important for smaller reactors which often use external heat removal to maintain cooling.

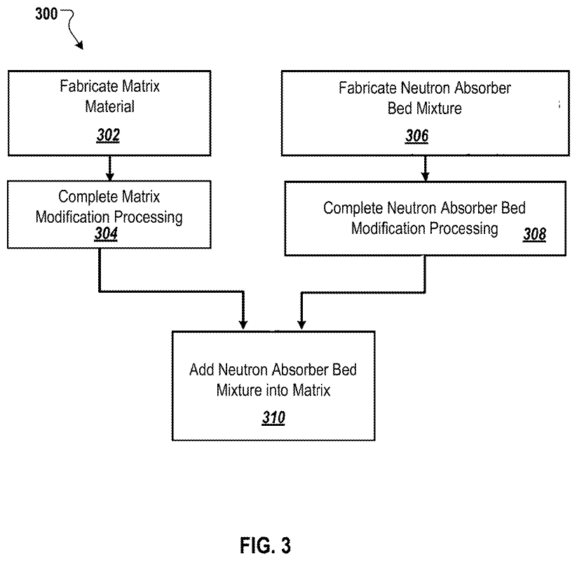

FIG. 3 shows a flow diagram of a process 300 of manufacture of the radiation shielding. The radiation shielding includes a neutron absorber mixture in a matrix material. The process 300 includes fabricating matrix material (302) and completing a matrix modification process (304). The matrix modification process can include coating. The matrices, molds, or containers can be fabricated and placed in geometric configurations to augment heat transfer in a desired direction, e.g., in a direction away from the reactor core. The arrangement of the matrices, molds, and containers can be adjusted (e.g., by including gas volumes) to improve the structural integrity of the shielding material and accommodate gas generation occurring over time, such as gas generation from neutron absorptions occurring in the absorber.

The process 300 includes fabricating a neutron absorber bed mixture (306). The neutron absorber mixture can include a selection of particle sizes and other additives to optimize bed properties. For example, the neutron absorber mixture can be optimized for qualities of porosity, conductivity, and heat capacity.

The process 300 includes completing the neutron absorber bed modification processing (308). The shielding material can be modified in a number of ways, including but not limited to mixing powders, packing the powders (e.g., vibrationally), and/or sintering the powders. In some examples, the sintering aids can include neutron or photon attenuating materials. The shielding material can also be modified by gas addition or removal, and by coating. The method of fabrication can include processes to modify surface properties such as radiative emissivity. Furthermore, gas within the absorber material can be modified, such as by drawing a vacuum to reduce thermal conductivity, or by adding helium to improve thermal conductivity.

The process 300 includes adding the neutron absorber bed mixture into the matrix (310). The powders can be loaded into pre-fabricated matrices (such as a metallic foams or porous media), molds, or containers, to match geometry requirements, or can be placed in bulk where needed.

In some configurations, neutron absorbing materials in a variety of compositions can be placed into control elements designed to help control reactivity of the reactor. The control elements can take the form of absorbers and reflectors located on the periphery of the reactor core. For example, the control elements can be located in the shielding regions surrounding the fuel region. In some examples, the control elements can be placed at intervals around the periphery of the reactor core.

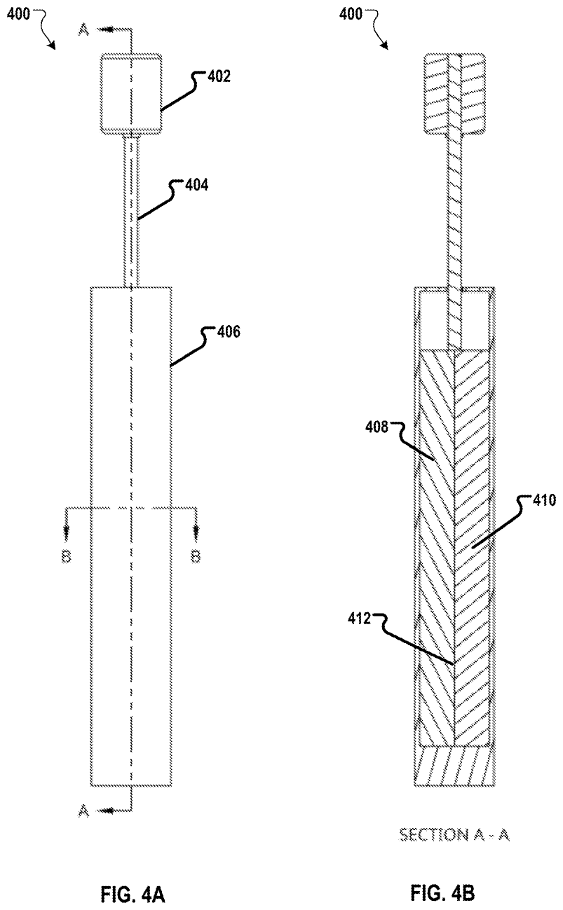

FIGS. 4A and 4B show a side view and a cross-sectional view of an example control drum 400, respectively. The control elements can take the form of a rotating container, or drum body 406, that contains both a reflector 408 including neutron reflecting materials, and an absorber 410 including neutron absorbing materials. For example, the reflector 408 can include neutron reflecting materials, such as metal or ceramic materials, including materials that contain zirconium, contained in a compartment of the drum. The absorber 410 can include neutron absorbing materials, e.g., boron containing materials, contained in another compartment of the drum. A divider 412 can be positioned in the drum body 406 to separate a compartment that contains the absorber 410 from a compartment that contains the reflector 408. The sizes, positions, shapes, and proportions of the compartments of the drum body 406 that contain the reflector 408 and the absorber 410 can vary depending on control requirements of the drum body 406, as well as the reactor design.

As shown in FIGS. 4A and 4B, the control drum 400 can include components such as a drum motor assembly 402, a transmission or shaft 404, and a rotating drum body 406. The components of the control drum 400 can be modularized and removable. For example, the components of the control drum 400 can be installed and removed together, or can be installed and removed individually. For example, the motor assembly 402 can be removed from the control drum 400 while the shaft 404 and the drum body 406 remain in place. Thus, maintainability and serviceability of the control drum 400 can be improved.

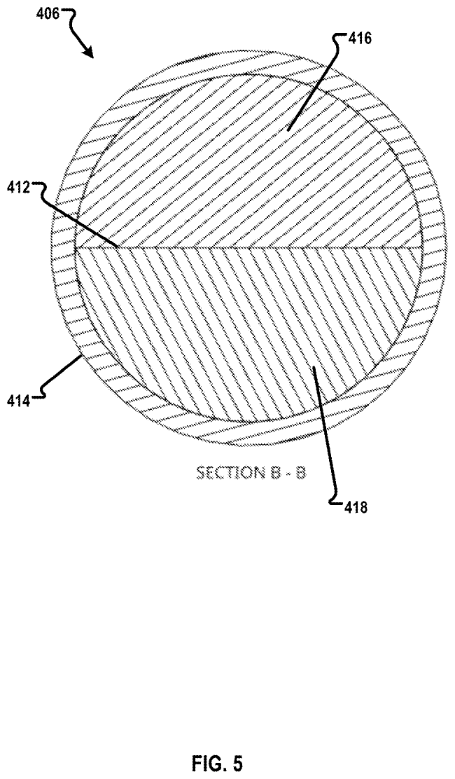

FIG. 5 shows a top cross-sectional view of an example control drum body. The example control drum body includes a cylindrical container housing an absorber and a reflector, separated by a divider. The drum body can be fabricated so that a fraction of the cylindrical contains the reflector, and the remaining fraction of the cylindrical container contains the absorber. For example, in FIG. 5, the divider 412 divides the container into two compartments 416, 418 of equal volume. Thus, half of the volume of the container contains the absorber 410, and half of the volume of the container contains the reflector 408. The materials of the reflector 408 and the absorber 410 can be a solid material, a composite, or a powder. The materials can be mixed or graded based on their neutron reflection and absorption characteristics to achieve the desired performance.

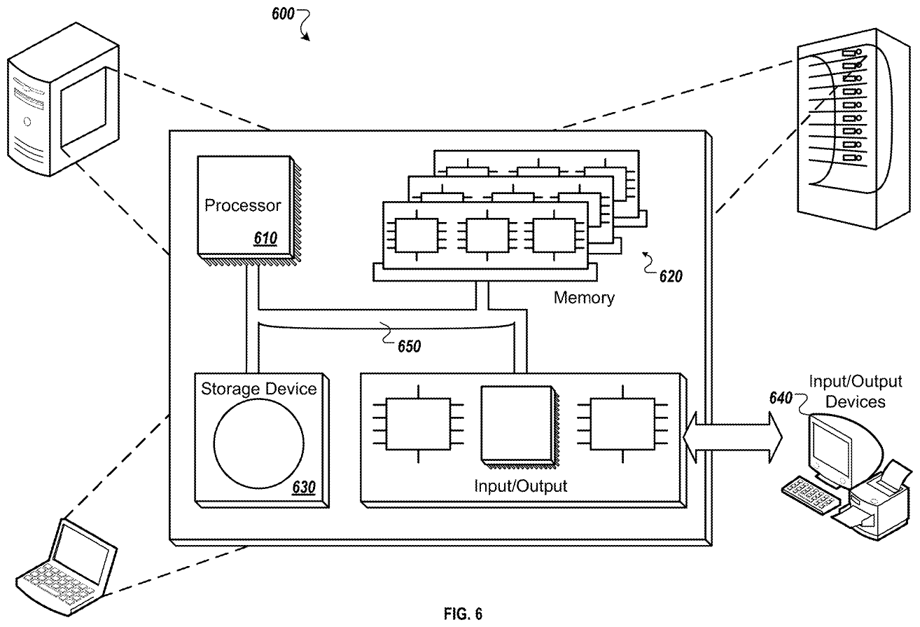

FIG. 6 is a schematic diagram of a computer system 600. The system 600 can be used to carry out the operations described in association with any of the computer-implemented methods described previously, according to some implementations. In some implementations, computing systems and devices and the functional operations described in this specification can be implemented in digital electronic circuitry, in tangibly-embodied computer software or firmware, in computer hardware, including the structures disclosed in this specification (e.g., system 600) and their structural equivalents, or in combinations of one or more of them. The system 600 is intended to include various forms of digital computers, such as laptops, desktops, workstations, personal digital assistants, servers, blade servers, mainframes, and other appropriate computers. The system 600 can also include mobile devices, such as personal digital assistants, cellular telephones, smartphones, and other similar computing devices. Additionally, the system can include portable storage media, such as, Universal Serial Bus (USB) flash drives. For example, the USB flash drives may store operating systems and other applications. The USB flash drives can include input/output components, such as a wireless transducer or USB connector that may be inserted into a USB port of another computing device.

The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. The processor may be designed using any of a number of architectures. For example, the processor 610 may be a CISC (Complex Instruction Set Computers) processor, a RISC (Reduced Instruction Set Computer) processor, or a MISC (Minimal Instruction Set Computer) processor.

In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 may be a floppy disk device, a hard disk device, an optical disk device, a tape device, or a solid state device.

The input/output device 640 provides input/output operations for the system 600. In one implementation, the input/output device 640 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A radiation shielding apparatus, comprising:
a matrix comprising matrix material; and
a mixture positioned in the matrix, the mixture comprising:
a neutron thermalizing material; and
a neutron absorbing material mixed with the neutron thermalizing material.

2. The radiation shielding apparatus of claim 1, wherein the neutron absorbing material is mixed with the neutron thermalizing material to form a homogeneous mixture or a functionally graded mixture.

3. The radiation shielding apparatus of claim 1, wherein the neutron thermalizing material comprises a hydrogenous material.

4. The radiation shielding apparatus of claim 1, wherein the neutron absorbing material comprises one or more of a boron-bearing material or a gadolinium-bearing material.

5. The radiation shielding apparatus of claim 1, further comprising a thermally conductive material mixed with the neutron thermalizing material and the neutron absorbing material.

6. The radiation shielding apparatus of claim 1, further comprising an insulating material mixed with the neutron thermalizing material and the neutron absorbing material.

7. The radiation shielding apparatus of claim 1, wherein the matrix material comprises one or more of metallic foams or porous media.

8. A reactivity control system, comprising:
a container rotatable around an axis and configured to house a neutron absorber and a neutron reflector;
a divider positioned inside the container to define two or more compartments within the container;
at least one neutron absorber positioned in at least one of the two or more compartments; and
at least one neutron reflector positioned in at least another of the two or more compartments that is fluidly isolated from the at least one of the two or more compartments.

9. The reactivity control system of claim 8, wherein the divider extends in one or more planes parallel to the axis.

10. The reactivity control system of claim 8, wherein the container comprises a cylindrical shape.

11. The reactivity control system of claim 8, wherein the two or more compartments are each of equal volume.

12. The reactivity control system of claim 8, further comprising:
a transmission coupled to the container around the axis; and
a motor coupled to the container through the transmission and configured to rotate the container around the axis through the transmission.

13. A method of manufacturing a radiation shielding material, comprising:
fabricating a matrix;
generating a mixture by mixing a neutron absorbing material, a neutron thermalizing material, and one or more additive materials; and
loading the mixture into the matrix.

14. The method of claim 13, wherein fabricating the matrix comprises:
fabricating matrix material;
modifying the matrix material; and
arranging the matrix material in a geometric configuration.

15. The method of claim 14, wherein the matrix material comprises one or more of metallic foams or porous media.

16. The method of claim 14, wherein modifying the matrix material comprises coating the matrix material.

17. The method of claim 13, further comprising modifying the mixture by one or more of vibrational packing, gas addition, gas removal, or coating.

18. The method of claim 13, wherein the neutron absorbing material, the neutron thermalizing material, and the one or more additive materials each comprise a granular material, and wherein generating the mixture comprises one or more of mixing the granular materials, packing the granular materials, or sintering the granular materials.

19. The method of claim 18, wherein the granular material comprises a powder.

20. The method of claim 13, wherein the mixture comprises a homogeneous mixture or a functionally graded mixture.

21. The method of claim 13, wherein the neutron thermalizing material comprises one or more of a hydrogenous material, a boron-bearing material, or a gadolinium-bearing material.

22. The method of claim 13, wherein the one or more additive materials comprise one or more of a photon attenuating material, a thermally conductive material, or an insulating material.
